(19) United States
(12) Patent Application Publication
(10) Pub. No.: US 2026/0352080 A1
(43) Pub. Date: Nov. 5, 2026

(54) VOLTAGE CONVERSION DEVICE AND METHOD

(71) Applicant: NUVOTON TECHNOLOGY CORPORATION, HSINCHU CITY (TW)

(72) Inventor: Chun-Ku LIN, zhubei City (TW)

(21) Appl. No.: 19/368,307

(22) Filed: Oct. 24, 2025

(30) Foreign Application Priority Data
May 1, 2025 (TW) 114116496

(51) Int. Cl. H02M 1/00; G06N 20/20; H02M 3/07

(52) U.S. Cl. CPC H02M 1/0006; G06N 20/20; H02M 1/0009; H02M 1/0012; H02M 3/07

(57) ABSTRACT

A voltage conversion device including: a charge pump circuit converting an input voltage to an output voltage based on an operating voltage and a clock, a voltage conversion rate of the charge pump circuit being dynamically adjustable; the operating voltage generation circuit including a Zener diode and for receiving an adjustment signal and generating the operating voltage based on a conducting state of the Zener diode and the adjustment signal; a temperature detection module for detecting a temperature; a machine learning module using a trained machine learning model to infer a breakdown voltage of the Zener diode based on the input voltage, a current flowing through the Zener diode, and the temperature; an adjustment module generating an adjustment signal based on a breakdown voltage and an operating voltage target, and adjusting the voltage conversion rate of the charge pump circuit based on the current flowing through the Zener diode.

### CROSS-REFERENCE TO RELATED APPLICATION

This application claims the benefit of Taiwan Patent Application No. 114116496, filed on May 1, 2025, in the Taiwan Intellectual Property Office, the disclosure of which is incorporated herein in its entirety by reference.

### BACKGROUND OF THE INVENTION

### 1. Field of the Invention

The present invention relates to a voltage conversion technology, and more particularly to a voltage conversion device and a method thereof for adjusting voltage conversion based on an input voltage by using machine learning techniques.

### 2. Description of the Related Art

The purpose of the voltage conversion device is to convert an input voltage into an output voltage by a preset conversion rate, which can be a conversion rate greater than 1 or less than 1. Common voltage conversion devices are, for example, charge pump devices, or switched capacitor power conversion devices.

As the application of the voltage conversion device becomes more and more widespread, the input voltage of the voltage conversion device may have a wide voltage range of 2.8V to 20V. For example, after the system where the voltage conversion device is located is powered on, the input voltage gradually rises from 0 to a target value, it affects the output voltage of the voltage conversion device to change significantly and fail to stay within a preset range, so the performance of the entire system is impacted.

In view of this, what is needed is to develop a voltage conversion device and a method thereof that can use machine learning techniques to adjust a voltage conversion rate based on an input voltage, so as to reduce the change amplitude of the output voltage of the voltage conversion device.

### SUMMARY OF THE INVENTION

The object of the present invention is to provide a voltage conversion device and a method thereof, to solve the above problems.

In order to achieve the above object, the present invention discloses a voltage conversion device including a charge pump circuit, an operating voltage generation circuit, a temperature detection module, a first machine learning module, and an adjustment module. The charge pump circuit is configured to convert an input voltage to an output voltage based on an operating voltage and a clock, wherein a voltage conversion rate of the charge pump circuit is dynamically adjustable. The operating voltage generation circuit includes a Zener diode and is configured to receive an adjustment signal and generate the operating voltage based on a conducting state of the Zener diode and the adjustment signal. The temperature detection module is configured to detect a temperature. The first machine learning module is configured to use a trained first machine learning model to infer a breakdown voltage of the Zener diode based on the input voltage, a current flowing through the Zener diode, and the temperature. The adjustment module is configured to generate the adjustment signal based on the breakdown voltage and an operating voltage target and adjust the voltage conversion rate of the charge pump circuit based on the current flowing through the Zener diode.

Based on an embodiment, the present invention further discloses a voltage conversion device including a charge pump circuit, an operating voltage generation circuit, a temperature detection module, a machine learning module and an adjustment module. The charge pump circuit is configured to convert an input voltage into an output voltage based on an operating voltage and a clock, wherein a voltage conversion rate of the charge pump circuit is dynamically adjustable. The operating voltage generation circuit includes a Zener diode and is configured to generate the operating voltage based on a conducting state of the Zener diode and an adjustment signal. The temperature detection module is configured to detect a temperature. The machine learning module is configured to use a machine learning model, which is trained, to infer the adjustment signal based on the input voltage, a current flowing through the Zener diode, an input current, a charge-pump current, and the temperature. The adjustment module is configured to adjust the voltage conversion rate of the charge pump circuit based on the current flowing through the Zener diode.

Based on an embodiment, the present invention further discloses a voltage conversion method including steps of: providing a charge pump circuit, wherein the charge pump circuit includes a charge pump stage configured to convert an input voltage to an output voltage based on an operating voltage and a clock, and a voltage conversion rate of the charge pump circuit is dynamically adjustable; providing an operating voltage generation circuit, wherein the operating voltage generation circuit includes a Zener diode configured to receive an adjustment signal and generate the operating voltage based on a conducting state of the Zener diode and the adjustment signal; detecting a temperature; using a first machine learning model, which is trained, to infer a breakdown voltage of the Zener diode based on the input voltage, a current flowing through the Zener diode, and the temperature; generating the adjustment signal based on a breakdown voltage of the Zener diode and the operating voltage target, and adjusting the voltage conversion rate of the charge pump circuit based on the current flowing through the Zener diode.

According to the above technical solution, the present invention uses machine learning technologies to assist the voltage conversion device in adjusting the voltage conversion rate based on the input voltage, thereby reducing the variation of the output voltage of the voltage conversion device.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a first embodiment of a voltage conversion device of the present invention.

FIG. 2 is a block diagram of a second embodiment of a voltage conversion device of the present invention.

FIG. 3 is a schematic diagram of a training phase of a machine learning model of the present invention.

FIG. 4 is a block diagram of a first embodiment of a voltage conversion method of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and descriptions to refer to the same or like parts. As used herein, the singular forms “a”, “an” and “the” are intended to include the plural forms as well, unless the context clearly indicates otherwise.

It is to be acknowledged that, although the terms ‘first,’ second,’ third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

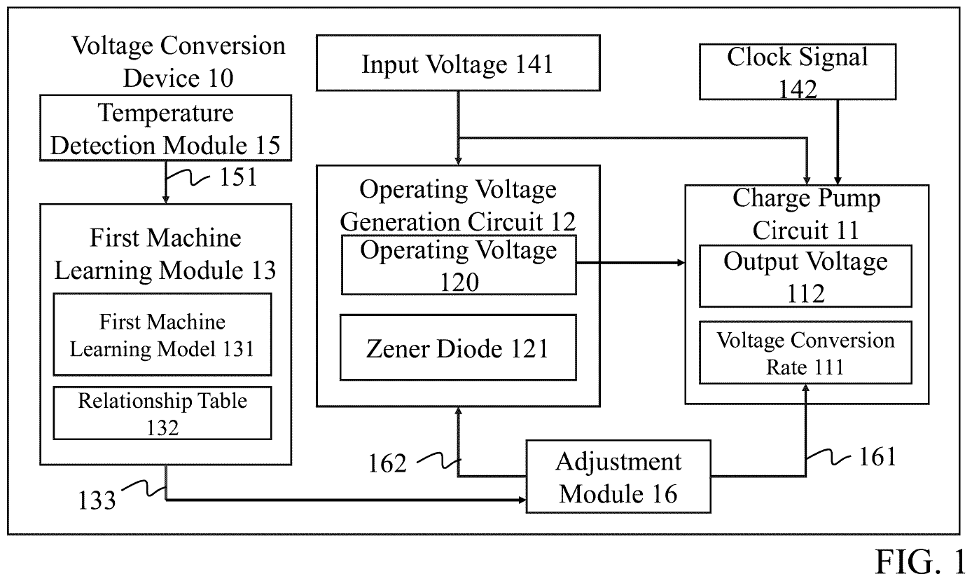

Please refer to FIG. 1, which shows a block diagram of a first embodiment of a voltage conversion device of the present invention. As shown in FIG. 1, the voltage conversion device 10 includes a charge pump circuit 11, an operating voltage generation circuit 12, a temperature detection module 15, a first machine learning module 13, and an adjustment module 16.

The charge pump circuit 11 converts an input voltage 141 to an output voltage 112 based on an operating voltage 120 and a clock signal 142. A voltage conversion rate 111 of the charge pump circuit 11 is dynamically adjustable. The temperature detection module 15 is configured to detect a temperature 151. In an embodiment, the charge pump circuit can include charge pump stages connected in series, each of the charge pump stages includes a diode and a capacitor, and these diodes are connected in series.

The operating voltage generation circuit 12 includes a Zener diode 121 and is configured to receive an adjustment signal 162 and generate the operating voltage 120 based on a conducting state of the Zener diode 121 and the adjustment signal 162. The first machine learning module 13 uses a trained first machine learning model 131, to infer a breakdown voltage 133 of the Zener diode 121 based on the input voltage 141, a current flowing through the Zener diode 121, and the temperature 151.

In an embodiment, the operating voltage generation circuit 12 includes a current mirror circuit and a variable voltage generation unit, the current mirror circuit has a first terminal coupled to the input voltage through the variable voltage generation unit, a second terminal coupled to the input voltage, a third terminal coupled to the Zener diode, and a fourth terminal coupled to the first machine learning module, so that the current flowing through the Zener diode flows through the third terminal. The current mirror circuit is a mirror current to generate a mirror current flowing through the fourth terminal. The variable voltage generation unit generates the operating voltage and receives the adjustment signal to adjust the operating voltage. The first machine learning model 131 is trained by using the input voltage 141, the current flowing through the Zener diode 121, and a relationship table 132 between the temperature 151 and the breakdown voltage of the Zener diode 121.

The adjustment module 16 generates an adjustment signal 162 based on a breakdown voltage 133 and an operating voltage target and generates a control signal 161 based on a current flowing through the Zener diode 121 for adjusting a voltage conversion rate 111 of the charge pump circuit 11.

In an embodiment, the voltage conversion device 10 includes a second machine learning module and a calculation module. The second machine learning module uses a second machine learning model, which is trained in advance, to infer a forward bias of each of the diodes based on the input voltage, an input current, a charge-pump current, and the temperature. The calculation module calculates the operating voltage target based on the forward bias. The adjustment module 16 generates an adjustment signal 162 based on the breakdown voltage 133 and the calculated operating voltage target.

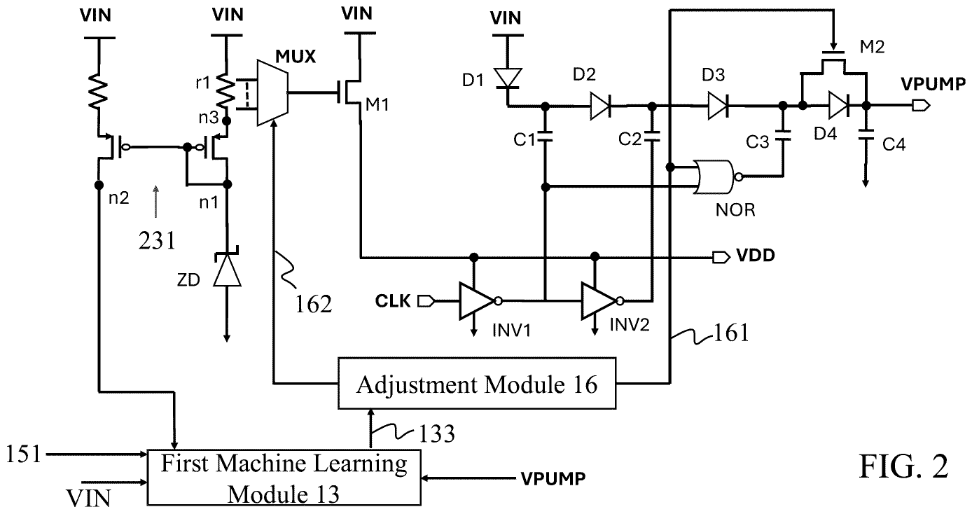

FIG. 2 is a circuit diagram of a second embodiment of a voltage conversion device of the present invention. As shown in FIG. 2, the voltage conversion device includes a charge pump circuit, an operating voltage generation circuit, a current mirror circuit 231, a first machine learning module 13, and a selection circuit. It should be noted that the voltage conversion circuit of this embodiment is implemented by using a Dickson charge pump circuit, but the present invention is not limited to this example. The operating voltage generation circuit in FIG. 1 includes a current mirror circuit 231 and a variable voltage generation unit. The charge pump circuit includes a selection circuit for dynamically adjusting a voltage conversion rate of the charge pump circuit. The charge pump circuit includes a NOR gate and a switch, which is implemented by a transistor M2.

The charge pump circuit in FIG. 2 includes charge pump stages connected in series and inverters INV1 and INV2 connected in series. Each of the charge pump stages includes a diode and a capacitor, the inverters INV1 and INV2 operate with an operating voltage VDD, an input terminal of the inverter INV1 receives a clock signal CLK, the diodes D1 to D4 are connected in series, the anode of the diode D1 receives an input voltage VIN, a capacitor C1 is connected between the cathode of the diode D1 and an output terminal of the inverter INV1, a capacitor C2 is connected between the cathode of the diode D2 and an output terminal of the inverter INV2, a capacitor C3 is connected between the cathode of the diode D3 and an output terminal of the NOR gate, and a capacitor C4 is connected between the cathode of the diode D4 and a ground terminal. The voltage at the cathode of the diode D4 serves as an output voltage VPUMP.

The switch of the selection circuit (i.e., the transistor M2) is connected in parallel with the diode D4, in other words, when the switch M2 is turned on, the diode D4 is bypassed, and the voltage conversion rate of the charge pump circuit is a lower value, for example, 2 times. When the switch M2 is not turned on, the diode D4 is not bypassed and the voltage conversion rate of the charge pump circuit is a higher value, for example, 3 times.

The variable voltage generation unit includes a resistor r1, a multiplexer MUX, a transistor M1, and a Zener diode ZD. The resistor r1 is coupled to a third terminal n3 of the current mirror circuit 231, which is the drain of the p-type transistor shown in FIG. 2. The resistor r1 includes sub-resistor segments connected in series, the sub-resistor segments are respectively coupled to an input terminal of the multiplexer MUX, an output terminal of the multiplexer MUX is coupled to a gate of the transistor M1, and a control terminal of the multiplexer MUX receives an adjustment signal 162 outputted by the adjustment module 16. The voltage at the source of the transistor M1 serves as the operating voltage. When receiving different adjustment signal 162, the multiplexer MUX can output a corresponding voltage of the sub-resistor segment, thereby adjusting the voltage received by the gate of the transistor M1 by the adjustment signal 162, and thus achieving the effect of adjusting the operating voltage.

A first terminal n1 of the current mirror circuit 231 is connected to a cathode of the Zener diode ZD, a second terminal n2 of the current mirror circuit 231 is coupled to the first machine learning module 13. The current mirror circuit 231 can mirror a first current flowing through the first terminal n1 and generate a mirror current at the second terminal n2. The mirror current and the first current have a proportional relationship according to the design, and a 1:1 proportional relationship is taken as an example for description herein. The first current is a current IZD flowing through the Zener diode ZD.

When power starts to be supplied to the voltage conversion device, the input voltage VIN gradually rises from 0. During the period when the input voltage VIN is not higher than the breakdown voltage of the Zener diode ZD, the Zener diode ZD does not enter a breakdown state (i.e., the Zener diode 121 is not yet turned on), the current IZD is very small and negligible, so the operating voltage VDD is the input voltage VIN minus the threshold voltage of the transistor M1, and varies along with the input voltage VIN. Since the current IZD is very small, the mirror current is also very small. The voltage of the control signal 161 outputted by the adjustment module 16 is a logic low level, which turns off the switch (i.e., the transistor M2), and the diode D4 is not bypassed, so that the voltage conversion rate of the charge pump circuit is set to a higher value.

During the period when the input voltage VIN is higher than the breakdown voltage of the Zener diode ZD, the Zener diode ZD enters a breakdown state (i.e., the Zener diode 121 is turned on), the current IZD becomes obviously larger, and the voltage of the gate of the transistor M1 is clamped between the breakdown voltage (the breakdown voltage) of the Zener diode ZD and the input voltage, at this time, the sub-resistor segments of the resistor r1 form a voltage-divider circuit, which can determine the voltage of the gate of the transistor M1 through the adjustment signal. Therefore, the operating voltage VDD is the breakdown voltage of the Zener diode ZD plus the partial voltage of the selected sub-resistor segment, and then minus the threshold voltage of the transistor M1, so the operating voltage VDD does not vary along with the input voltage VIN. The voltage of the control signal 161 outputted by the adjustment module 16 is a logic high level, which turns on the switch (i.e., the transistor M2), and the diode D4 is bypassed, so that the voltage conversion rate of the charge pump circuit is affected and reduced, that is, the voltage conversion rate of the charge pump circuit is set to a lower value.

According to the above description, the first machine learning module 13 can infer a more accurate breakdown voltage 133 of the Zener diode 121, and can more effectively use a higher value of voltage conversion rate when the Zener diode ZD is not turned on and the operating voltage VDD is low, and use a lower value of the voltage conversion rate when the Zener diode ZD is turned on and the operating voltage VDD is high, thereby keeping the output voltage VPUMP of the charge pump circuit within a preset range. For example, the input voltage is in a range of 2.8V to 20V, the operating voltage VDD is in a range of 2.3V to 5V, and the voltage conversion rate of the charge pump circuit can be switched to 2× or 3×, respectively.

In an embodiment, the voltage conversion device in FIG. 2 includes a second machine learning module and a calculation module. The second machine learning module uses a second machine learning model, which is trained in advance, to infer a forward bias of each of the diodes based on the input voltage, an input current, a charge-pump current, and the temperature. In an embodiment, the calculation module calculates an operating voltage target VDD based on the following formula (1) and formula (2), and then provides the calculated operating voltage target VDD to the adjustment module for subsequent processing,

VDD=((VPUMP+Vd)−VIN)/N+Vd Formula (1)

VPUMP=Vover−stress upper limit+VIN Formula (2)
wherein N is the number of stages of the charge pump, VIN is the input voltage, Vd is the forward bias of the diode, VPUMP is the output voltage of the charge pump circuit, Vover-stress upper limit is an upper limit value of over stress, and the VDD is an operating voltage target.

In an embodiment, according to the above description, the second machine learning module can infer a more accurate forward bias of the diode, thereby obtaining a more accurate operating voltage target VDD.

In an embodiment, the first machine learning module and the second machine learning module are integrated into a single machine learning model, which can infer an adjustment signal based on the input voltage a current, an input current, a charge-pump current flowing through the Zener diode, and the temperature after being trained.

In some embodiments, the above machine learning module can perform machine learning model training using one or more well-known artificial intelligence (AI) learning algorithms or machine learning algorithms. These algorithms can include neural networks (e.g., artificial neural networks, deep neural networks, convolutional neural networks (CNN), recurrent neural networks (RNN), autoencoders, reinforcement learning, etc.), fuzzy logic, artificial intelligence (AI), deep learning algorithms, deep structured learning hierarchical learning algorithms, support vector machines (SVM) (e.g., linear SVM, nonlinear SVM, SVM regression), decision tree learning (e.g., classification and regression trees (CART)), dimensionality reduction algorithms (e.g., projection, manifold learning, principal component analysis, etc.), and/or deep machine learning algorithms.

The implementation of the machine learning module may at least include a training phase (also known as a learning phase) and an inference phase (also known as a generation phase). In the training phase, the machine learning module 12 compares an actual output thereof with a correct output (or an output that is at least closer to the desired output) to find an error, and modifies the model accordingly, thereby performing training. In the inference phase, the trained machine learning module is configured in the voltage conversion device and provides an output corresponding to any input.

It should be noted that the machine learning module can be implemented in various ways, including software, hardware, or any combination thereof. For example, in some embodiments, the machine learning module 12 can be implemented by software and hardware or one of them, for example, using a processor with sufficient computing power to execute program instructions to run the algorithm of the machine learning model, to implement the machine learning module. In addition, the machine learning module of the present invention can also be partially or completely implemented based on hardware, for example, the machine learning module can be implemented through an integrated circuit chip, a system on chip (SoC), a complex programmable logic device (CPLD), or a field programmable gate array (FPGA). The computer readable instructions used to perform the operations of the present invention can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C #, Perl, Ruby or PHP; the programming language can include regular procedural programming languages, such as C language or similar programming languages.

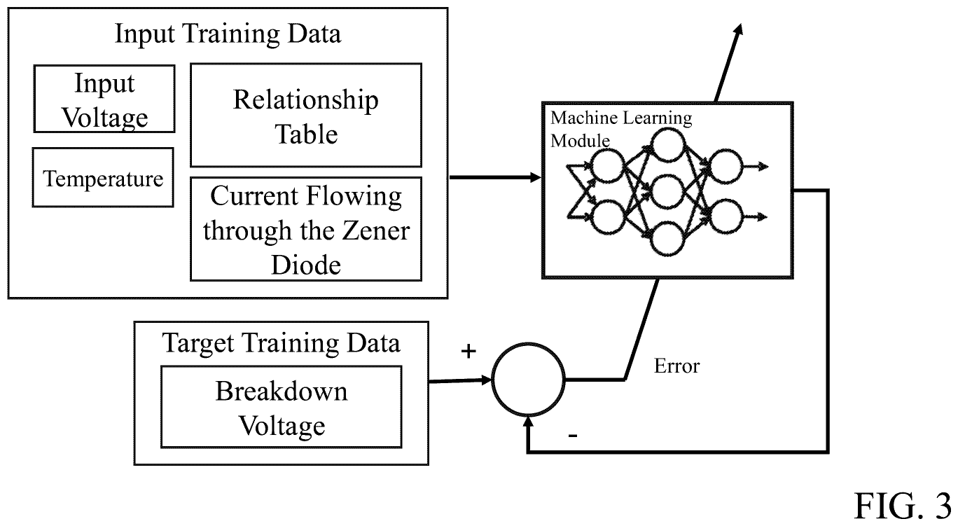

Please refer to FIG. 3. FIG. 3 shows a schematic diagram of the training phase of the machine learning model of the present invention. The training dataset used by the machine learning module of the present invention includes input training data and target training data. The input training data includes process information, input voltages, and currents flowing through the Zener diode, a relationship table between temperatures and breakdown voltages of the Zener diode, and the target training data includes the breakdown voltages of the Zener diode. The above training dataset is inputted into the machine learning module for training the machine learning model. Taking the collection of training data for the first machine learning model as an example, the process information can be stored in a memory, the user can input the input voltages in a stepwise manner, and when one of the input voltages is inputted, a current flowing through the Zener diode and a temperature are simultaneously measured, at which time the Zener diode can be calculated from the input voltage and the current flowing through the Zener diode. In a condition that the user gradually increases the input voltage, when the current of the Zener diode suddenly increases, it means that the Zener diode enters a breakdown state at this time, so the breakdown voltage of the Zener diode can be calculated based on the connection circuit structure of the input voltage and the Zener diode. Similarly, the user can change the temperature of the voltage conversion device or input different process information of the voltage conversion device and repeat the above data collection process. According to the above method, input training data corresponding to different processes and different temperatures can be collected and used to train the first machine learning module.

Taking the collection of training data for the second machine learning model as an example, the process information can be stored in a memory, the current of the charge pump circuit is set as 0, the user inputs input voltages in a stepwise manner, an output voltage of the charge pump circuit is simultaneously measured when one of the input voltages is inputted, and a forward bias of the diode is calculated based on the input voltage, the output voltage of the charge pump circuit, and the following formula (3):

Vd=(VIN−VPUMP)/N Formula (3)
wherein, n is the number of stages of the charge pump, VIN is the input voltage, Vd is the forward bias of the diode, VPUMP is the output voltage of the charge pump circuit.

Similarly, the user can change temperatures of the voltage conversion device or input different process information of voltage conversion devices and repeat the above data collection process. According to the above method, input training data corresponding to different processes and different temperatures can be collected and used to train the second machine learning module.

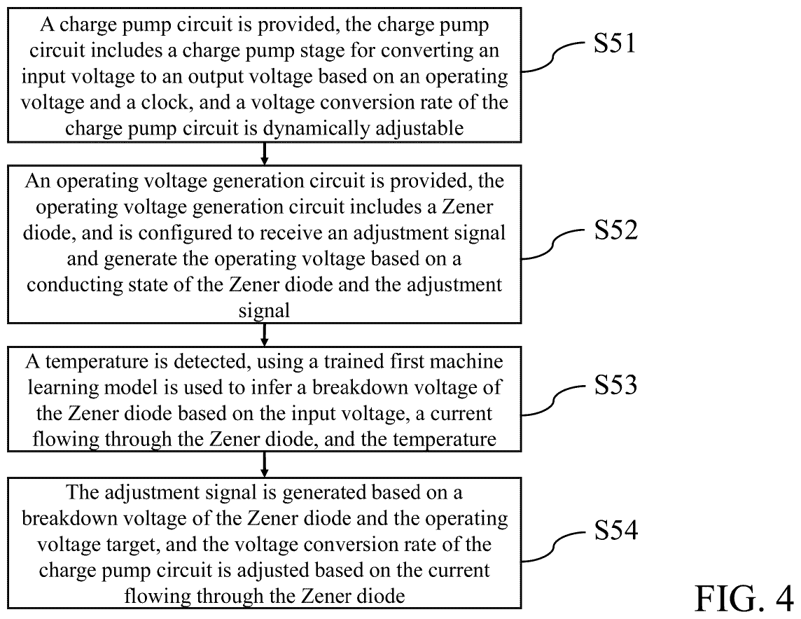

Please refer to FIG. 4. FIG. 4 shows a flowchart of a voltage conversion method of the present invention. As shown in FIG. 4, the voltage conversion method of the present invention includes the following steps. In step S51, a charge pump circuit is provided, the charge pump circuit includes a charge pump stage for converting an input voltage to an output voltage based on an operating voltage and a clock, and a voltage conversion rate of the charge pump circuit is dynamically adjustable. In step S52, an operating voltage generation circuit is provided, the operating voltage generation circuit includes a Zener diode, and is configured to receive an adjustment signal and generate the operating voltage based on a conducting state of the Zener diode and the adjustment signal. In step S53, a temperature is detected, using a trained first machine learning model is used to infer a breakdown voltage of the Zener diode based on the input voltage, a current flowing through the Zener diode, and the temperature. In step S54, the adjustment signal is generated based on a breakdown voltage of the Zener diode and the operating voltage target, and the voltage conversion rate of the charge pump circuit is adjusted based on the current flowing through the Zener diode.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A voltage conversion device, comprising:
a charge pump circuit, configured to convert an input voltage to an output voltage based on an operating voltage and a clock, wherein a voltage conversion rate of the charge pump circuit is dynamically adjustable;
an operating voltage generation circuit, comprising a Zener diode, and configured to receive an adjustment signal and generate the operating voltage based on a conducting state of the Zener diode and the adjustment signal;
a temperature detection module, configured to detect a temperature;
a first machine learning module, configured to use a trained first machine learning model to infer a breakdown voltage of the Zener diode based on the input voltage, a current flowing through the Zener diode, and the temperature; and
an adjustment module, configured to generate the adjustment signal based on the breakdown voltage and an operating voltage target, and adjust the voltage conversion rate of the charge pump circuit based on the current flowing through the Zener diode.

2. The voltage conversion device according to claim 1, wherein the operating voltage generation circuit comprises a current mirror circuit and a variable voltage generation unit, the current mirror circuit has a first terminal coupled to the input voltage through the variable voltage generation unit, a second terminal coupled to the input voltage, a third terminal coupled to the Zener diode, and a fourth terminal coupled to the first machine learning module, so that the current flowing through the Zener diode flows through the third terminal, and the current mirror circuit mirrors the current to generate a mirror current flowing through the fourth terminal, wherein the variable voltage generation unit generates the operating voltage and receives the adjustment signal to adjust the operating voltage.

3. The voltage conversion device according to claim 1, wherein the charge pump circuit comprises charge pump stages connected in series, each of the charge pump stages comprises a diode and a capacitor, and the diodes are connected in series.

4. The voltage conversion device according to claim 3, comprising:
a second machine learning module, configured to use a second machine learning model, which is trained, to infer a forward bias of each of the diodes based on the input voltage, an input current, a charge-pump current, and the temperature; and
a calculation module, configured to calculate the operating voltage target based on the forward bias.

5. The voltage conversion device according to claim 1, wherein the first machine learning model is trained by using the input voltage, the current flowing through the Zener diode, and a relationship table between the temperature, and the breakdown voltage of the Zener diode.

6. A voltage conversion device, comprising:
a charge pump circuit, configured to convert an input voltage into an output voltage based on an operating voltage and a clock, wherein a voltage conversion rate of the charge pump circuit is dynamically adjustable;
an operating voltage generation circuit, comprising a Zener diode, and configured to generate the operating voltage based on a conducting state of the Zener diode and an adjustment signal;
a temperature detection module, configured to detect a temperature;
a machine learning module, configured to use a machine learning model, which is trained, to infer the adjustment signal based on the input voltage, a current flowing through the Zener diode, an input current, a charge-pump current, and the temperature; and
an adjustment module, configured to adjust the voltage conversion rate of the charge pump circuit based on the current flowing through the Zener diode.

7. The voltage conversion device according to claim 6, wherein the operating voltage generation circuit comprises a current mirror circuit and a variable voltage generation unit, the current mirror circuit has a first terminal coupled to the input voltage through the variable voltage generation unit, a second terminal coupled to the input voltage, a third terminal coupled to the Zener diode, and a fourth terminal coupled to the machine learning module, so that the current flowing through the Zener diode flows through the third terminal, and the current mirror circuit mirrors the current to generate a mirror current flowing through the fourth terminal, wherein the variable voltage generation unit generates the operating voltage and receives the adjustment signal to adjust the operating voltage.

8. The voltage conversion device according to claim 6, wherein the charge pump circuit comprises charge pump stages connected in series, each of the charge pump stages comprises a diode and a capacitor, and the diodes are connected in series.

9. A voltage conversion method, comprising:
providing a charge pump circuit, wherein the charge pump circuit comprises a charge pump stage configured to convert an input voltage to an output voltage based on an operating voltage and a clock, and a voltage conversion rate of the charge pump circuit is dynamically adjustable;
providing an operating voltage generation circuit, wherein the operating voltage generation circuit comprises a Zener diode configured to receive an adjustment signal and generate the operating voltage based on a conducting state of the Zener diode and the adjustment signal;
detecting a temperature;
using a first machine learning model, which is trained, to infer a breakdown voltage of the Zener diode based on the input voltage, a current flowing through the Zener diode, and the temperature; and
generating the adjustment signal based on a breakdown voltage of the Zener diode and the operating voltage target, and adjusting the voltage conversion rate of the charge pump circuit based on the current flowing through the Zener diode.

10. The voltage conversion method according to claim 9, wherein the charge pump circuit comprises charge pump stages connected in series, each of the charge pump stages comprises a diode and a capacitor, the diodes are connected in series, and the voltage conversion method further comprises:
using a second machine learning model, which is trained, to infer a forward bias of each of the diodes based on the input voltage, an input current, a charge-pump current, and the temperature; and
calculating the operating voltage target based on the forward bias.
